(19) United States
(12) Patent Application Publication
(10) Pub. No.: US 2009/0103114 A1
(43) Pub. Date: Apr. 23, 2009

(54) Multifunction printer and method for confirming preview image

(75) Inventor: Tatsuo Nishimura, Tokyo (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/289,070

(22) Filed: Oct. 20, 2008

(30) Foreign Application Priority Data
Oct. 22, 2007 (JP) 2007-274128
May 27, 2008 (JP) 2008-138150

(51) Int. Cl. G06K 15/10; G09G 5/00

(52) U.S. Cl. 358/1.5; 345/619

(57) ABSTRACT

A multifunction printer including a display unit configured to display a preview image in which a finished image and an image of a finishing option which have an effect on the finished image are combined; a correction unit configured to correct a position of the finished image in the preview image; an input unit configured to input a correction value for correcting the position of the finished image; and a display unit configured to display a preview image in which the finished image, the position of which is corrected based on the correction value, and the image of the finishing option are combined.

### PRIORITY STATEMENT

The present patent application claims priority from Japanese Patent Application Nos. 2007-274128, filed on Oct. 22, 2007 in the Japan Patent Office, and 2008-138150, filed on May 27, 2008 in the Japan Patent Office, the entire contents of each of which are hereby incorporated herein by reference.

### BACKGROUND

1. Technical Field

Illustrative embodiments generally relate to a multifunction printer capable of displaying a preview image of a page to be printed in which a position of an image is appropriately corrected for printing, and a method for confirming the preview image.

2. Description of the Related Art

Some related-art multifunction printers having two or more of copying, printing, scanning, and facsimile functions are able to display a finished image to be output as a preview image on a screen.

For example, the multifunction printer may display a preview image in which a finished image of an image to be printed on a sheet and an image of finishing options, such as hole punching and stapling selected by a user, are combined, thus enabling the user to confirm the position of punched holes or staples in the sheet and whether or not the punched holes or the staples overlap the image in the preview image displayed on the screen before the image is actually printed on the sheet.

However, because duplex printing requires mechanically reversing and physically repositioning the sheet on both sides of which an image is printed, when duplex printing is performed, a position of the image to be printed on a back side of the sheet may be slightly misaligned compared to a position of an image to be printed on a front side of the sheet. Consequently, even when the user has confirmed that the punched holes or the staples do not overlap the image in the preview image, the punched holes or the staples may in fact overlap the image when the image is actually printed on the sheet.

### SUMMARY

In view of the foregoing, illustrative embodiments provide a multifunction printer capable of providing a preview image so that a user may reliably confirm a finished image of an image to be output before the image is actually printed on a sheet, even when misalignment of the image may occur due to the need to mechanically reverse and physically reposition the sheet on both sides of which an image is printed.

At least one embodiment provides a multifunction printer including a display unit configured to display a preview image in which a finished image and an image of a finishing option which have an effect on the finished image are combined; a correction unit configured to correct a position of the finished image in the preview image; an input unit configured to input a correction value for correcting the position of the finished image; and a display unit configured to display a preview image in which the finished image, the position of which is corrected based on the correction value, and the image of the finishing option are combined.

At least one embodiment provides a method for confirming a preview image including displaying a preview image in which a finished image and an image of a finishing option which have an effect on the finished image are combined; inputting a correction value for correcting a position of the finished image; and displaying a preview image in which the finished image, the position of which is corrected based on the correction value, and the image of the finishing option are combined.

Additional features and advantages of the illustrative embodiments will be more fully apparent from the following detailed description, the accompanying drawings, and the associated claims.

### BRIEF DESCRIPTION OF THE DRAWINGS

A more complete appreciation of illustrative embodiments and the many attendant advantages thereof will be readily obtained as the same becomes better understood by reference to the following detailed description when considered in connection with the accompanying drawings, wherein:

FIG. 1 is a block diagram illustrating a hardware configuration of a multifunction printer according to illustrative embodiments;

FIG. 2 is a functional block diagram of the multifunction printer;

FIG. 3 is a view illustrating an example of a comparison between an original preview image and a preview image in which a position of an image is horizontally and vertically corrected;

FIG. 4A is a flow chart of a process of horizontally and vertically correcting the position of the image;

FIG. 4B is a graph explaining how to horizontally and vertically correct the position of the image;

FIG. 5 is a view illustrating an example of a screen displayed when correction values for correcting the position of the image are input;

FIG. 6 is a view illustrating how the screen changes on an LCD touch panel;

FIG. 7 is a view illustrating comparison between an original preview image of the back side of the sheet and a mirror image thereof;

FIG. 8A is a flow chart of a process of creating the mirror image;

FIG. 8B is a graph explaining how to create the mirror image;

FIG. 9 is a view illustrating changes in the preview images in a case in which punched holes are moved leftward when viewed from a front side of the sheet;

FIG. 10 is a view illustrating the LCD touch panel on an operation port;

FIG. 11 is a view illustrating an example of a screen for adjusting a position of the punched holes;

FIG. 12 is a view illustrating a combined preview image in which a preview image of the front side of the sheet and the mirror image of the back side of the sheet are combined;

FIG. 13 is a flow chart of a process of combining the preview image of the front side of the sheet and the mirror image of the back side of the sheet;

FIG. 14 is a view illustrating switching between a normal preview image and the combined preview image;

FIG. 15 is a view illustrating switching of a print preview screen between the normal preview image and the combined preview image;

FIG. 16 is a view illustrating an example of the preview image in which a part of the image is positioned within a range of the punched holes;

FIG. 17 is a view illustrating an example of a guidance message;

FIG. 18A is a flow chart of a process of automatically calculating a correction value for moving the position of the punched holes;

FIG. 18B is a graph explaining how to automatically calculate the correction value for moving the position of the punched holes; and

FIG. 19 is a view illustrating an example of a message.

The accompanying drawings are intended to depict illustrative embodiments and should not be interpreted to limit the scope thereof. The accompanying drawings are not to be considered as drawn to scale unless explicitly noted.

### DETAILED DESCRIPTION OF ILLUSTRATIVE EMBODIMENTS

In describing illustrative embodiments illustrated in the drawings, specific terminology is employed for the sake of clarity. However, the disclosure of this specification is not intended to be limited to the specific terminology so selected, and it is to be understood that each specific element includes all technical equivalents that operate in a similar manner and achieve a similar result.

Reference is now made to the drawings, wherein like reference numerals designate identical or corresponding parts throughout the several views.

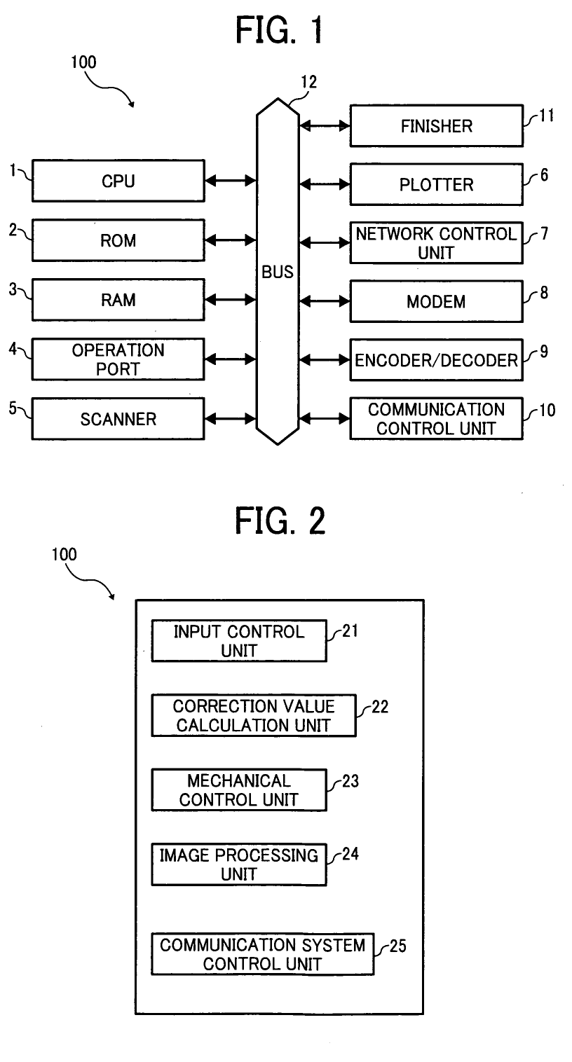

FIG. 1 is a block diagram illustrating a hardware configuration of a multifunction printer 100 according to illustrative embodiments. Referring to FIG. 1, the multifunction printer 100 includes a CPU 1 configured to control the multifunction printer 100; a ROM 2 storing programs and data used for controlling the multifunction printer 100; a RAM 3 storing a variety of data used for controlling the multifunction printer 100; an operation port 4 configured to input commands from a user and report information to the user; a scanner 5 configured to read original documents; a plotter 6 configured to print or output images; a network control unit 7 configured to control a communication network; a modem 8 configured to modulate transmission signals and demodulate reception signals; an encoder/decoder 9 configured to encode image data in accordance with a predetermined encoding method and decode encoded image data; a communication control unit 10 configured to control communication between the multifunction printer 100 and a communication destination; a finisher 11 configured to punch or staple printed sheets; and a bus 12 connecting the above-described components.

FIG. 2 is a functional block diagram of the multifunction printer 100. An input control unit 21 is configured to display a guidance message to the user and process data input by the user, and may be implemented by the operation port 4 controlled by the CPU 1. A correction value calculation unit 22 is configured to compare a position of punched holes with a position of an image to appropriately calculate a correction value, and may be implemented by the CPU 1. A mechanical control unit 23 is configured to control various mechanisms, and may be implemented by the scanner 5, the plotter 6, and the finisher 11, each controlled by the CPU 1. An image processing unit 24 is configured to perform processes ranging from reading original documents to printing images. Further, the image processing unit 24 is configured to move the position of the image, reverse the image, or superimpose the image, and may be implemented by the ROM 2, the RAM 3, the scanner 5, and the plotter 6, each controlled by the CPU 1. A communication system control unit 25 is configured to control a communication system, and may be implemented by the network control unit 7, the modem 8, the encoder/decoder 9, and the communication control unit 10, each controlled by the CPU 1.

A description is now given of a print preview screen in which a position of an image to be printed on a sheet may be appropriately corrected when, for example, hole punching is set as a finishing option.

When hole punching is set as a finishing option, an image of punched holes to be provided on a sheet may be combined with a finished image of the image to be printed so as to display a composite preview image on the print preview screen. When duplex printing is performed, a preview image of a back side of the sheet may be displayed on the print preview screen in a similar manner as described above so that the user may reliably obtain a desired finished image of the back side of the sheet as well.

A method like that disclosed in JP-A-2007-013924, the disclosure of which is incorporated herein for this purpose, may be used to display the preview image described above.

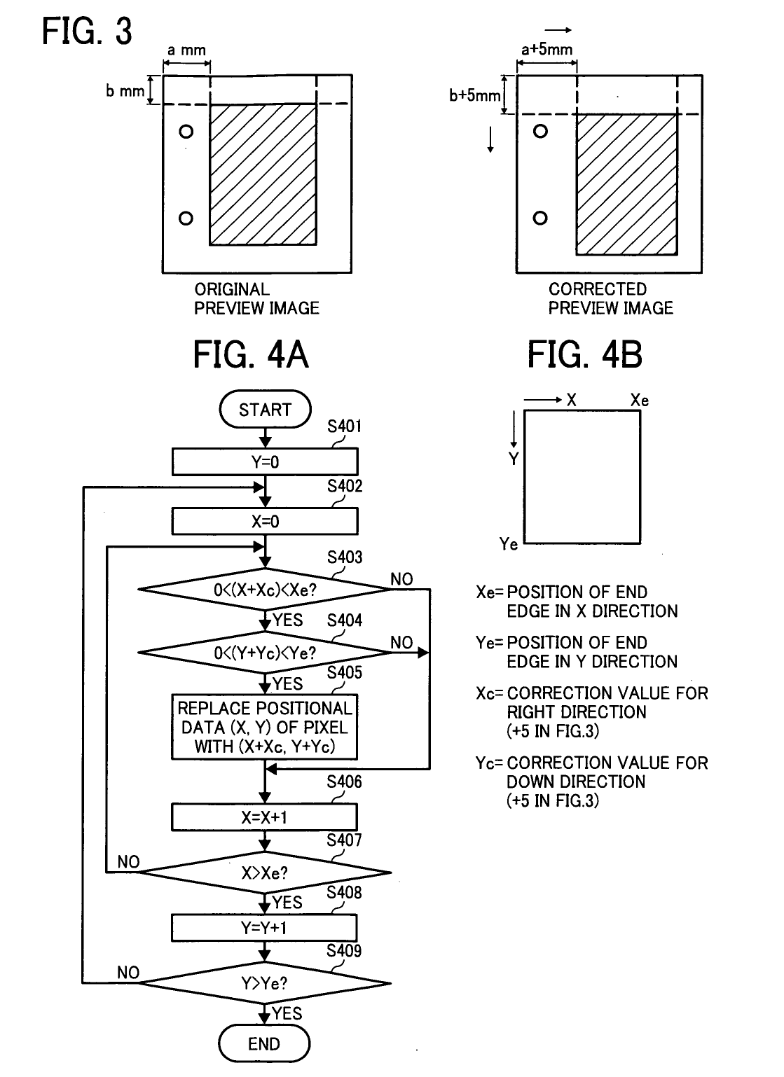

FIG. 3 is a view illustrating an example of comparison between an original preview image and a preview image in which the position of the image is horizontally and vertically corrected so that the image and the punched holes do not overlap.

Steps for correcting the position of the image in horizontal and vertical directions are described in detail below with reference to FIG. 4A.

At S401, Y is set to 0 as a default value. At S402, X is set to 0 as a default value. At S403, determination of whether (X+Xc) is greater than 0 and smaller than Xe is performed. Here, Xe indicates a horizontal width of the sheet, and is obtained by a well-known method. When (X+Xc) is greater than Xe (No at S403), it means that the image lies off the sheet, and therefore, printing is not performed. By contrast, when (X+Xc) is greater than 0 and smaller than Xe (Yes at S403), at S404, determination of whether (Y+Yc) is greater than 0 and smaller than Ye is performed. Here, Ye indicates a vertical width of the sheet, and is obtained by a well-known method. When (Y+Yc) is greater than 0 and smaller than Ye (Yes at S404), at S405, pixel positional data (X, Y) is replaced with (X+Xc, Y+Yc). At S406, X is incremented by 1 until X becomes greater than Xe (Yes at S407). Thereafter, at S408, Y is incremented by 1 until Y becomes greater than Ye (Yes at S409), and the series of processes is finished.

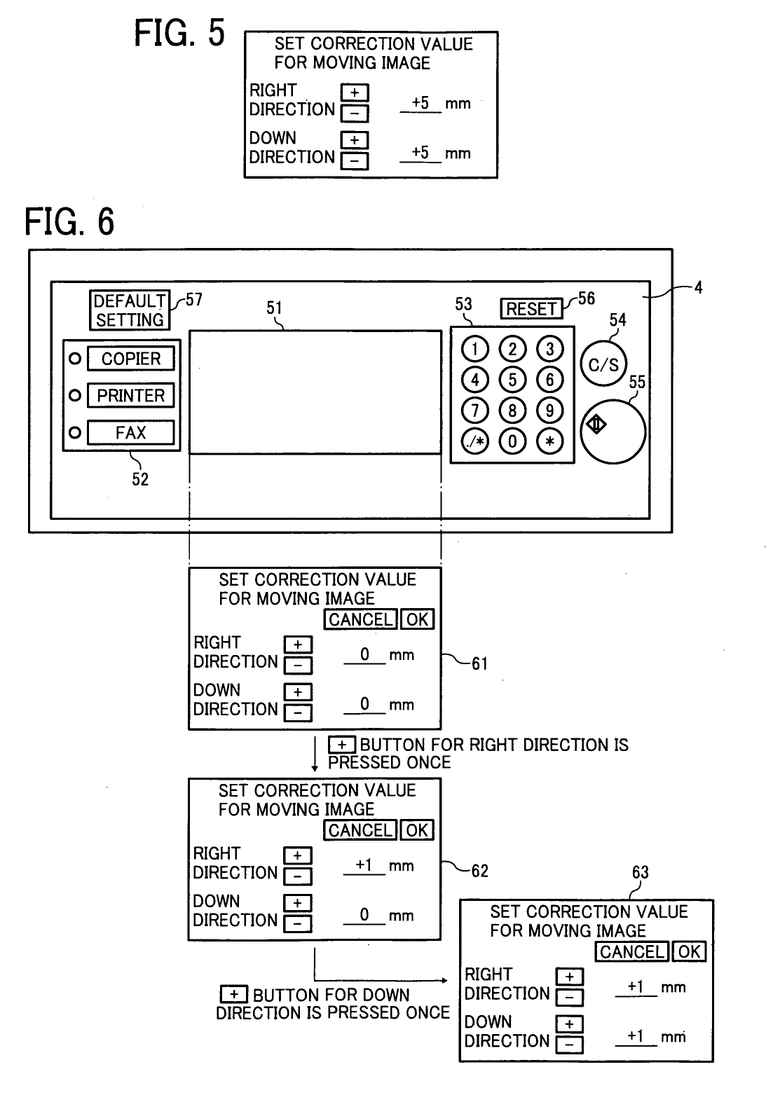

The user may input correction values for moving the image in the horizontal and vertical directions through, for example, the operation port 4. FIG. 5 is a view illustrating an example of a screen displayed when the user inputs the correction values. FIG. 6 is a view illustrating how the screen changes when the user inputs the correction values.

A description is now given of how to input the correction values through the screen with reference to FIGS. 5 and 6.

The operation port 4 includes an LCD touch panel 51, an application switching button 52, a group of numeric keys 53, a clear/stop button 54, a start button 55, a mode reset button 56, and a default setting button 57. First, the default setting button 57 is pressed, and a predetermined button in the group of numeric keys 53 is pressed to display an input screen 61 on the LCD touch panel 51. A screen 62 is displayed on the LCD touch panel 51 by pressing once a “+” button for the right direction, and a screen 63 is displayed by further pressing once a “+” button for the down direction. When desired values for each of the directions are set by pressing each of the buttons, those values are set as the correction values for each of the directions by pressing an OK button.

A description is now given of a method for displaying a horizontally reversed image of the back side of the sheet on the print preview screen.

When confirming that the punched holes are positioned over the image on the print preview screen, the user may reposition the image so as to avoid the punched holes as described above. Alternatively, however, the user may adjust a position of the punched holes so that the punched holes do not overlap the image. After the user has input correction values for adjusting the position of the punched holes, the print preview screen is displayed again and the user may confirm whether or not the position of the punched holes is moved to an optimum position.

In duplex printing, the position of the punched holes needs to be properly set such that the punched holes do not overlap the images on both the front and back sides of the sheet. However, on the print preview screen, the punched holes provided along a left edge of the sheet when viewed from the front side of the sheet are provided along a right edge of the sheet when viewed from the back side of the sheet. Further, when the position of the punched holes is moved leftward in the preview image of the front side of the sheet on the print preview screen, those punched holes are moved rightward in the preview image of the back side of the sheet. Consequently, it is difficult for the user to easily confirm and change the position of the punched holes on the print preview screen.

To simplify the operation performed by the user, the preview image of the back side of the sheet is divided into minimum units of pixels, and the pixels in the horizontal direction of the preview image are reversely arranged so that a horizontally reversed image (hereinafter referred to as a mirror image) of the back side of the sheet, that is, the preview image on the back side of the sheet viewed through the front side of the sheet, is created. Accordingly, the position of the punched holes on the back side of the sheet in the mirror image displayed on the print preview screen becomes identical to the position of the punched holes on the front side of the sheet. Further, the position of the punched holes on the back side of the sheet in the mirror image is also moved leftward when the position of the punched holes on the front side of the sheet is moved leftward. As a result, the position of the punched holes on both the front and back sides of the sheet may be easily adjusted, thereby simplifying operation for the user.

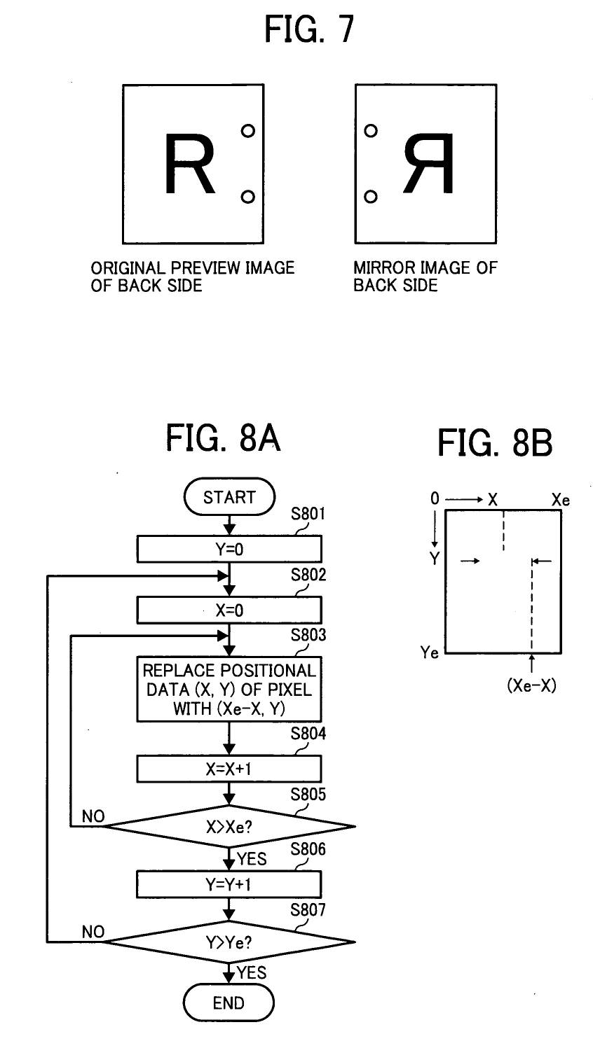

FIG. 7 is a view illustrating comparison between an original preview image of the back side of the sheet and the mirror image thereof when two punched holes are provided in a vertical direction along the left edge of the sheet in duplex printing.

Steps for creating the mirror image of the back side of the sheet are described in detail below with reference to FIG. 8A.

At S801, Y is set to 0 as, a default value. At S802, X is set to 0 as a default value. It is to be noted that the image does not lie off the sheet because the image is simply to be reversed in the horizontal direction. Xe indicates a horizontal width of the sheet, and Ye indicates a vertical width of the sheet. Both Xe and Ye are obtained by a well-known method. At S803, pixel positional data (X, Y) is replaced with (Xe−X, Y). At S804, X is incremented by 1 until X becomes greater than Xe (Yes at S805). Thereafter, at S806, Y is incremented by 1 until Y becomes greater than Ye (Yes at S807), and the series of processes is finished.

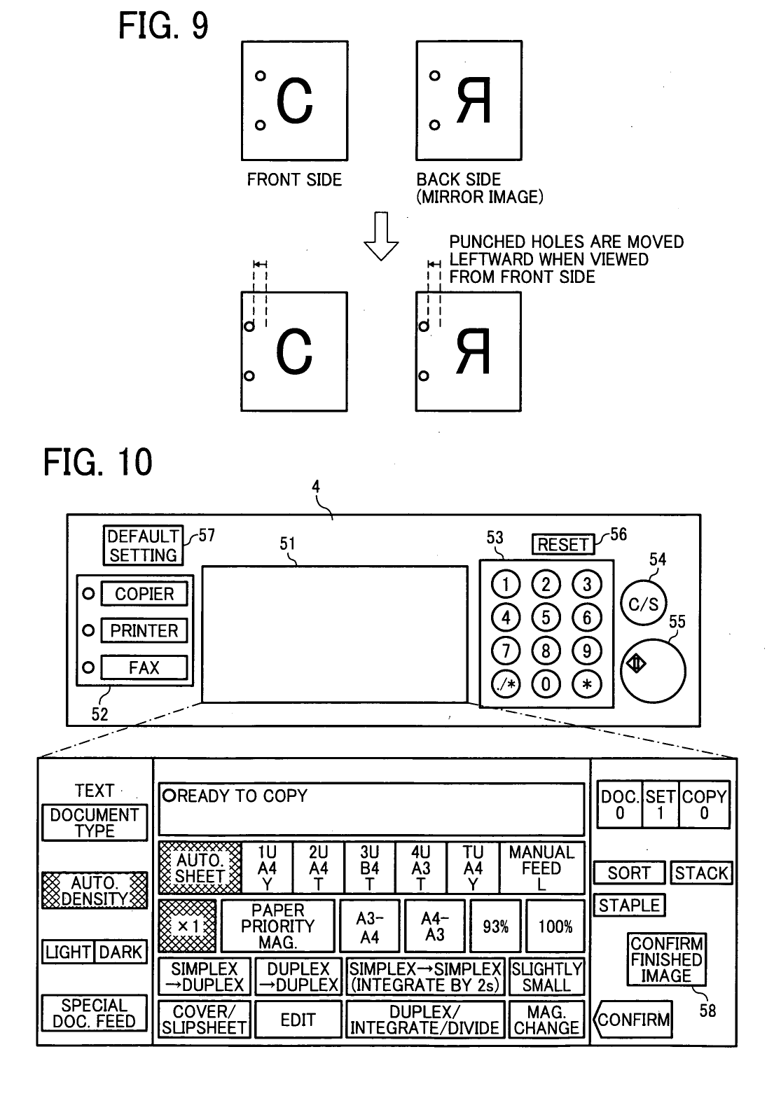

FIG. 9 is a view illustrating changes in the preview image of the front side of the sheet and the mirror image of the back side of the sheet displayed side by side on the print preview screen in a case in which the punched holes are moved leftward when viewed from the front side of the sheet. As illustrated in FIG. 9, because the position of the punched holes is identical in both images, the punched holes are moved leftward in both images.

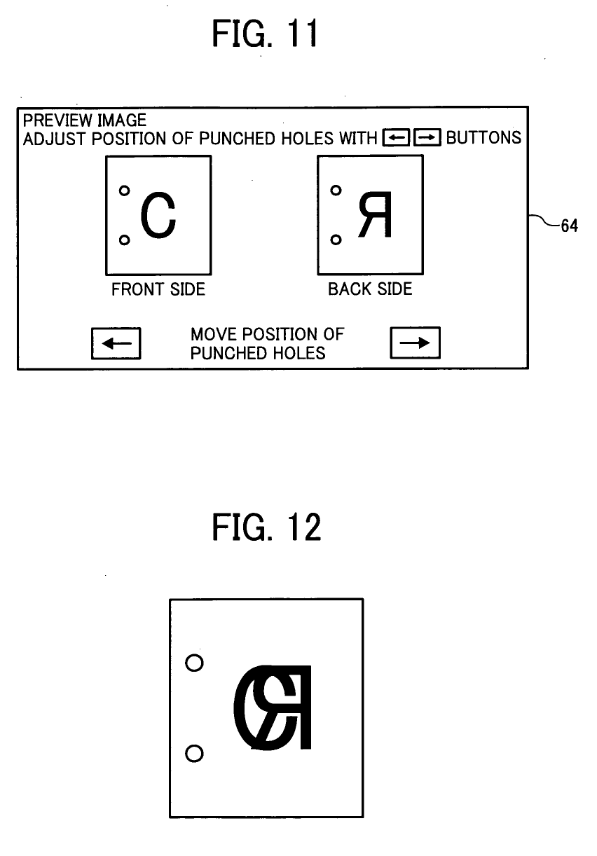

A description is now given of a screen displayed on the LCD touch panel 51 when the position of the punched holes is adjusted with reference to FIGS. 10 and 11.

FIG. 10 is a view illustrating the LCD touch panel 51 displayed on the operation port 4. The operation port 4 illustrated in FIG. 10 has the same configuration as that of the operation port 4 illustrated in FIG. 6.

When a confirm-finished image button 58 on the LCD touch panel 51 is pressed, an original document is read and a screen 64 illustrated in FIG. 11 is displayed on the LCD touch panel 51. On the screen 64, the position of the punched holes is moved in both the preview image of the front side of the sheet and the mirror image of the back side of the sheet each time a → or ← button is pressed. The position of the punched holes is moved farther from the original position thereof as the number of times the → or ← button is pressed increases. Duplex printing is performed when the start button 55 on the operation port 4 is pressed, and the sheet is punched in accordance with the input settings.

A description is now given of a print preview screen in which the preview image of the front side of the sheet and the mirror image of the back side of the sheet are combined, that is, are superimposed to form a composite preview image.

According to the foregoing illustrative embodiments, the preview image of the front side of the sheet and the mirror image of the back side of the sheet are separately displayed side by side on the print preview screen. Therefore, when the position of the punched holes is moved leftward by 5 mm in the preview image of the front side of the sheet, the position of the punched holes is moved leftward by 5 mm in the mirror image of the back side of the sheet as well on the print preview screen.

However, because the preview image of the front side of the sheet and the mirror image of the back side of the sheet are separately displayed on the print preview screen, the position of the punched holes on both sides of the sheet needs to be adjusted separately. Specifically, the user is required to check both the preview image of the front side of the sheet and the mirror image of the back side of the sheet on the print preview screen in order to set the correction value for moving the position of the punched holes which is appropriate for both sides of the sheet.

The multifunction printer 100 according to illustrative embodiments displays a print preview screen in which the preview image of the front side of the sheet and the mirror image of the back side of the sheet are combined in a single, superimposed, composite preview image. As a result, the user may easily check relative positions of the images and the punched holes on both sides of the sheet in the combined preview image, thereby facilitating operation by the user to set the position of the punched holes appropriate for both sides of the sheet.

FIG. 12 is a view illustrating the combined preview image displayed on the print preview screen, in which the preview image of the front side of the sheet and the mirror image of the back side of the sheet, respectively illustrated in FIG. 9, are combined, that is, superimposed to form a composite preview image.

One example of a method for combining the preview image of the front side of the sheet and the mirror image of the back side of the sheet like that shown in FIG. 12 is described in detail below.

First, the preview image of the front side of the sheet and the mirror image of the back side of the sheet, respectively, are divided into pixels. Subsequently, the pixels at the same coordinates in the preview image of the front side of the sheet and the mirror image of the back side of the sheet are compared. When a pixel exists in the preview image of the front side of the sheet but does not exist in the mirror image of the back side of the sheet, the pixel in the preview image of the front side of the sheet is adopted in the combined preview image. When the same pixel exists in both the preview image of the front side of the sheet and the mirror image of the back side of the sheet, the pixel in the preview image of the front side of the sheet is adopted in the combined preview image. In such a case, the pixel is displayed in black for monochrome images. However, when the images are multi-colored, either the pixels in the preview image of the front side of the sheet or the mirror image of the back side of the sheet is adopted in the combined preview image. Here, the pixel is displayed in a color of the pixel in the preview image of the front side of the sheet.

By contrast, when a pixel that does not exist in the preview image of the front side of the sheet is present in the mirror image of the back side of the sheet, the pixel in the mirror image of the back side of the sheet is adopted in the combined preview image. When no pixel exists in either the preview image of the front side of the sheet or the mirror image of the back side of the sheet, it is determined that no pixel exists at the coordinates in the combined preview image.

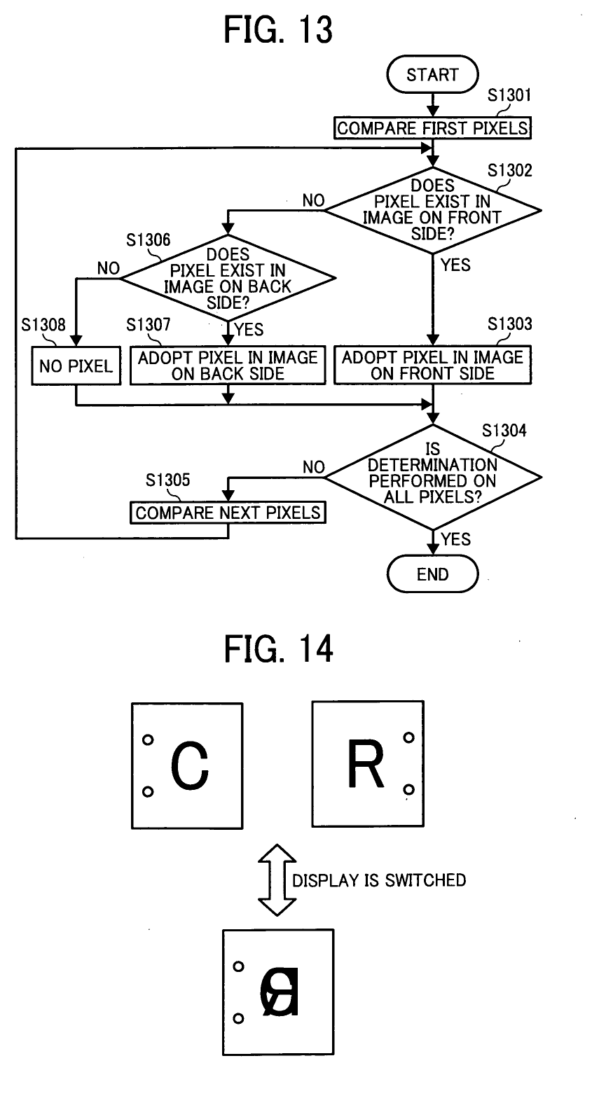

Steps for combining the preview image of the front side of the sheet and the mirror image of the back side of the sheet are described in detail below with reference to FIG. 13.

At S1301, first pixels at the same coordinates in the preview image of the front side of the sheet and the mirror image of the back side of the sheet are compared. At S1302, determination of whether or not the pixel exists in the preview image of the front side of the sheet is performed. When the pixel exists in the preview image of the front side of the sheet (Yes at S1302), at S1303, the pixel in the preview image of the front side of the sheet is adopted in the combined preview image.

Next, at S1304, determination of whether or not the above-described determination performed at S1302 has been already performed on all pixels is performed. When the above-described determination performed at S1302 is not yet performed on all pixels (No at S1304), at S1305, next pixels at the same coordinates in the preview image of the front side of the sheet and the mirror image of the back side of the sheet are compared with each other. Thereafter, the process returns to S1302.

When the pixel does not exist in the preview image of the front side of the sheet (No at S1302), the process proceeds to S1306 to determine whether or not the pixel exists in the mirror image of the back side of the sheet. When the pixel exists in the mirror image of the back side of the sheet (Yes at S1306), at S1307, the pixel in the mirror image of the back side of the sheet is adopted in the combined preview image, and the process proceeds to S1304. When the pixel does not exist in the mirror image of the back side of the sheet (No at S1306), at S1308, it is determined that no pixel exists at the coordinates in the combined preview image.

When the above-described steps are performed on all pixels (Yes at S1304), the series of processes is finished.

A description is now given of switching the print preview screen between the combined preview image and a normal preview image.

When the preview image of the front side of the sheet and the mirror image of the back side of the sheet are combined and displayed as the combined preview image on the print preview screen, the position of the punched holes appropriate for both sides of the sheet may be easily set, as described above. However, because images on both sides of the sheet are combined, neither of the images is clearly displayed on the print preview screen. Consequently, it is difficult for the user to reliably confirm the images.

To solve such a problem, the print preview screen may be switched between the combined preview image and the normal preview image in which the preview images of each of the front and back sides of the sheet are displayed separately side by side, thus enhancing user convenience by providing the advantages of both the normal preview image and the combined preview image.

The user may switch the print preview screen between the normal preview image and the combined preview image using the operation port 4. FIG. 14 is a view illustrating switching between the normal preview image and the combined preview image.

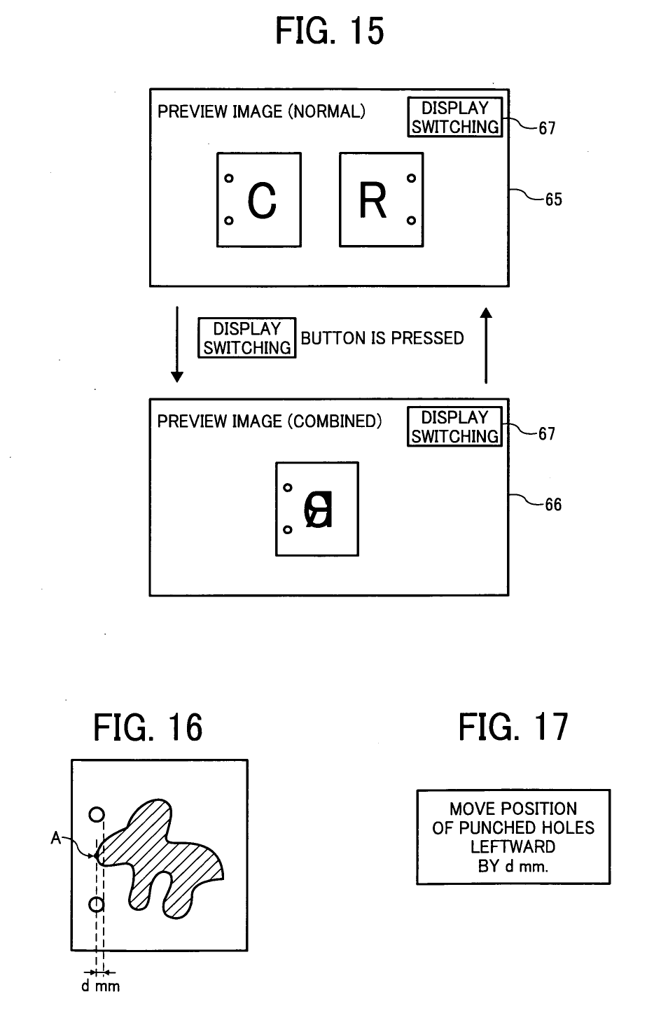

FIG. 15 is a view illustrating switching of the print preview screen between the normal preview image and the combined preview image. As illustrated in FIG. 15, a display switching button 67 is provided on screens 65 and 66 displayed on the LCD touch panel 51. The print preview screen is switched by pressing the display switching button 67.

A description is now given of a method for automatically calculating the correction value for moving the position of the punched holes.

When moving the position of the punched holes, the user is required to obtain the correction value for moving the position of the punched holes by actually measuring the relative positions of the images and the punched holes on the original document or the print preview screen using a ruler. Alternatively, the user is required to input a tentative value as the correction value as many times as needed until the position of the punched holes is properly set on the print preview screen.

The multifunction printer 100 according to illustrative embodiments is configured to automatically calculate the correction value for moving the position of the punched holes and notify the user of the correction value thus calculated when the image is positioned within the range of the punched holes. As a result, the user may easily obtain the appropriate correction value for moving the position of the punched holes, simplifying the operation of the user.

FIG. 16 is a view illustrating an example of the preview image in which a part of the image is positioned within the range of the punched holes. In FIG. 16, a point A is a left edge of the image positioned closest to the left edge of the sheet. In a case in which the image is printed on the sheet in such a state, the user may not see the image around the point A when the punched holes provided along the left edge of the sheet as illustrated in FIG. 16 are used for filing.

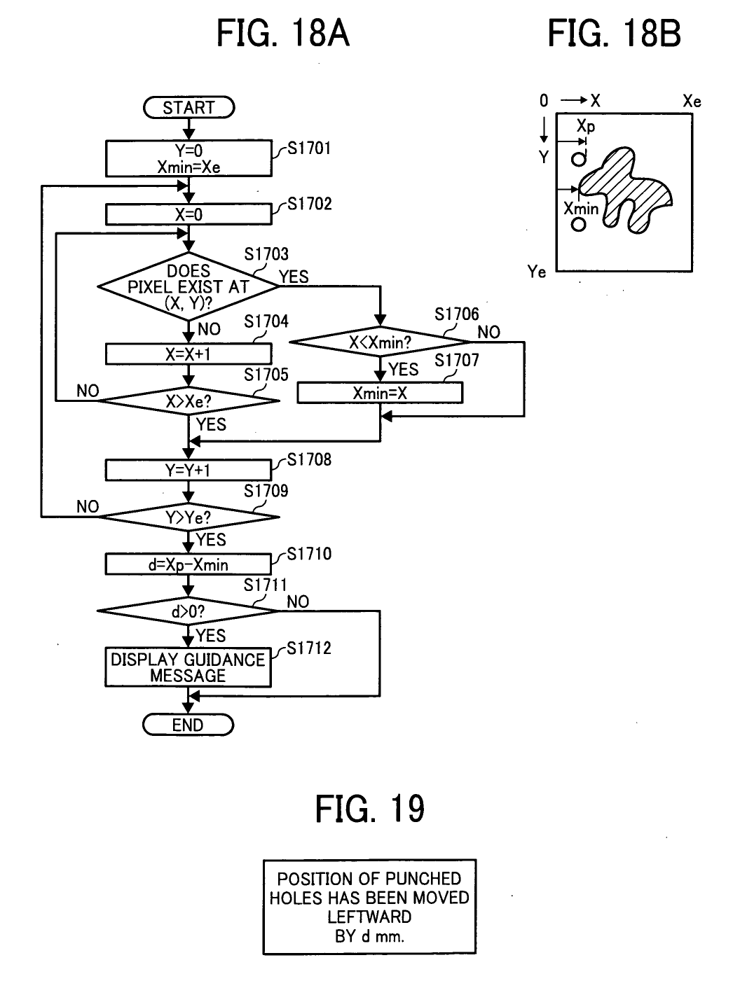

In order to solve such a problem, the multifunction printer 100 according to illustrative embodiments compares coordinates at the point A with coordinates of the punched holes to automatically calculate the correction value for moving the position of the punched holes. In the example illustrated in FIG. 16, the correction value automatically calculated by the multifunction printer 100 is d mm. A detailed description of one method used to calculate the correction value is given later, with reference to FIG. 18A.

FIG. 17 is a view illustrating an example of a guidance message displayed for prompting the user to move the position of the punched holes leftward by d mm. Here, as described above, the punched holes are vertically provided along the left edge of the sheet. In such a case, a distance between the left edge of the sheet and the point A is compared with a distance between the left edge of the sheet and the position of the punched holes. As a result, when the point A is positioned closer to the left edge of the sheet than the position of the punched holes is, the guidance message prompting the user to move the position of the punched holes leftward is displayed on the LCD touch panel 51. On the other hand, when the point A is not positioned closer to the left edge of the sheet than the position of the punched holes is, the guidance message is not displayed on the LCD touch panel 51. In a case in which the punched holes are provided along a top, right, or bottom edges of the sheet, distances from each of the point A and the position of the punched holes to the relevant edge of the sheet are used for performing the above-described processes.

Steps for automatically calculating the correction value for moving the position of the punched holes are described in detail with reference to FIG. 18A. At S1701, Y is set to 0 as a default value, and Xmin is set to Xe. Xe is the maximum value for Xmin obtained by a well-known method, and indicates a horizontal width of the sheet. Next, at S1702, X is set to 0 as a default value. At S1703, determination of whether or not a pixel exists at coordinates (X, Y) is performed. When the pixel does not exist at the coordinates (X, Y) (No at S1703), at S1704, X is incremented by 1. At S1705, determination of whether or not X is greater than Xe is performed. When X is not greater than Xe (No at S1705), the process returns to S1703. In contrast, when the pixel exists at the coordinates (X, Y) (Yes at S1703), at S1706, determination of whether or not X is smaller than Xmin is performed. When X is smaller than Xmin (Yes at S1706), at S1707, Xmin is set to X. Subsequently, at S1708, Y is incremented by 1. At S1709, determination of whether or not Y is greater than Ye is performed. When Y is not greater than Ye (No at S1709), the process returns to S1702. On the other hand, when Y is greater than Ye (Yes at S1709), Xmin is identified as the X coordinate of the pixel positioned closest to the left edge of the sheet.

Thereafter, at S1710, Xmin is subtracted from Xp, which is the X coordinate of the right edge of the punched hole, to obtain a difference d. At S1711, determination of whether or not the difference d is greater than 0 is performed. When the difference d is greater than 0 (Yes at S1711), at S1712, the guidance message illustrated in FIG. 17 is displayed on the LCD touch panel 51, and the series of processes is finished. By contrast, when the difference d is not greater than 0 (No at S1711), the series of processes is finished at this time.

A description is now given of a case in which the punched holes are provided on multiple sheets in the same document.

When the multiple sheets in the same document are punched, the punched holes are generally required to be provided at the same position in all the sheets.

The multifunction printer 100 according to illustrative embodiments is configured to automatically calculate the correction value for moving the position of the punched holes for each sheet and select the maximum value among the correction values thus calculated to notify the user of the maximum correction value. Accordingly, the user may easily set the appropriate correction value for moving the position of the punched holes in a case in which the images are printed on the multiple sheets, thereby simplifying the operation of the user.

When the punched holes are provided on the multiple sheets in the same document, the point A on each sheet is obtained to calculate values of the difference d for each sheet. The values of the difference d for each sheet thus calculated are compared with one another to obtain the maximum value among the difference d. Thereafter, the guidance message illustrated in FIG. 17 is displayed on the LCD touch panel 51 in the same manner as in the case described above.

The position of the punched holes may be automatically moved based on the difference d calculated as described above. A message illustrated in FIG. 19 may be displayed on the LCD touch panel 51 to notify the user that the position of the punched holes has been moved.

Because the correction value for moving the position of the punched holes is automatically set as described above, the user does not need to input the correction value, simplifying the operation of the user.

The position of the punched holes may be automatically moved at a time when the print preview screen is displayed. Alternatively, first, the original preview image may be displayed on the print preview screen, and subsequently, the position of the punched holes may be automatically moved by the operation of the user. For example, a button for automatically moving the position of the punched holes may be provided on the print preview screen so that the user may press that button to automatically move the position of the punched holes.

The foregoing illustrative embodiments may be effectively employed in a case in which staples are provided on the sheet in the same manner as the case in which the punched holes are provided on the sheet as described above.

Illustrative embodiments are not limited to the details described above, and various modifications and improvements are possible without departing from the spirit and scope of illustrative embodiments. It is therefore to be understood that, within the scope of the associated claims, illustrative embodiments may be practiced otherwise than as specifically described herein. For example, elements and/or features of different illustrative embodiments may be combined with each other and/or substituted for each other within the scope of illustrative embodiments.

What is claimed is:

1. A multifunction printer, comprising:
a display unit configured to display a preview image in which a finished image and an image of a finishing option which have an effect on the finished image are combined;
a correction unit configured to correct a position of the finished image in the preview image;
an input unit configured to input a correction value for correcting the position of the finished image; and
a display unit configured to display a preview image in which the finished image, the position of which is corrected based on the correction value, and the image of the finishing option are combined.

2. The multifunction printer according to claim 1, further comprising:
an adjustment unit configured to adjust a position of the finishing option; and
a display unit configured to display a preview image in which the finished image is divided into minimum units of pixels to reversely arrange the pixels in a horizontal direction of the finished image.

3. The multifunction printer according to claim 2, further comprising a display unit configured to display a combined preview image in which a preview image of a front side of a sheet and a mirror image of a preview image of a back side of the sheet are combined.

4. The multifunction printer according to claim 3, further comprising:
a selection unit configured to prompt a user to select either the combined preview image or a normal preview image in which the preview image of the front side of the sheet and the preview image of the back side of the sheet are displayed separately side by side; and
a display unit configured to display either the combined preview image or the normal preview image in response to an instruction from the user.

5. The multifunction printer according to claim 3, further comprising:
a first acquisition unit configured to obtain the position of the finishing option;
a second acquisition unit configured to obtain a pixel position in the images in the combined preview image closest to one of four edges of the sheet;
a calculation unit configured to calculate relative positions of the finishing option and the pixel;
a determination unit configured to determine whether or not the position of the finishing option is required to be moved relative to the images in the combined preview image based on the relative positions of the finishing option and the pixel; and
a notification unit configured to notify a user of a message to move the finishing option when needed and a correction value for moving the finishing option calculated based on the relative positions of the finishing option and the pixel.

6. The multifunction printer according to claim 5, further comprising:
a determination unit configured to determine whether or not the finishing option is required to be moved for each of multiple sheets;
a storing unit configured to calculate correction values for moving the finishing option for each of the multiple sheets when the finishing option is required to be moved and store the correction values;
a detector configured to detect a maximum value among the correction values; and
a notification unit configured to notify the user of the maximum value detected by the detector.

7. The multifunction printer according to claim 6, further comprising a changing unit configured to automatically change settings in accordance with the maximum value detected by the detector.

8. A method for confirming a preview image, comprising:
displaying a preview image in which a finished image and an image of a finishing option which have an effect on the finished image are combined;
inputting a correction value for correcting a position of the finished image; and
displaying a preview image in which the finished image, the position of which is corrected based on the correction value, and the image of the finishing option are combined.

9. The method for confirming a preview image according to claim 8, further comprising:
adjusting a position of the finishing option; and
displaying a preview image in which the finished image is divided into minimum units of pixels to reversely arrange the pixels in a horizontal direction of the finished image.

10. The method for confirming a preview image according to claim 9, further comprising displaying a combined preview image in which a preview image of a front side of a sheet and a mirror image of a preview image of a back side of the sheet are combined.

11. The method for confirming a preview image according to claim 10, further comprising:
prompting a user to select either the combined preview image or a normal preview image in which the preview image of the front side of the sheet and the preview image of the back side of the sheet are displayed separately side by side; and
displaying either the combined preview image or the normal preview image in response to an instruction from the user.

12. The method for confirming a preview image according to claim 10, further comprising:
obtaining the position of the finishing option;
obtaining a pixel position in the images in the combined preview image closest to one of four edges of the sheet;
calculating relative positions of the finishing option and the pixel;
determining whether or not the position of the finishing option is required to be moved relative to the images in the combined preview image based on the relative positions of the finishing option and the pixel; and
notifying a user to move the finishing option when needed and of a correction value for moving the finishing option calculated based on the relative positions of the finishing option and the pixel.

13. The method for confirming a preview image according to claim 12, further comprising:
determining whether or not the finishing option is required to be moved for each of multiple sheets;
calculating correction values for moving the finishing option for each of the multiple sheets when the finishing option is required to be moved to store the correction values;
detecting a maximum value among the correction values; and
notifying the user of the maximum value detected.

14. The method for confirming a preview image according to claim 13, further comprising automatically changing settings in accordance with the maximum value detected.
